(19) United States
(12) Patent Application Publication
(10) Pub. No.: US 2017/0117730 A1
(43) Pub. Date: Apr. 27, 2017

(54) EFFICIENT SUPERCAPACITOR CHARGING TECHNIQUE BY A HYSTERETIC CHARGING SCHEME

(71) Applicant: The Regents of the University of California, Oakland, CA (US)

(72) Inventors: Sehwan KIM, Kyeonggi-do (SK); Pai H. CHOU, Irvine, CA (US)

(73) Assignee: The Regents of the University of California, Oakland, CA (US)

(21) Appl. No.: 15/192,430

(22) Filed: Jun. 24, 2016

Related U.S. Application Data
(60) Provisional application No. 62/185,308, filed on Jun. 26, 2015.

(51) Int. Cl. H02J 7/00

(52) U.S. Cl. CPC H02J 7/0052; H02J 7/007; H02J 2007/0059

(57) ABSTRACT

An efficient supercapacitor charging scheme with low ambient energy sources is provided. In one embodiment, a charging apparatus is disclosed. The apparatus includes a burst control module, and a boost converter configured to control a two-stage supercapacitor composition. The boost converter may be a pulse-frequency modulation (PFM) dc-dc boost converter and the apparatus may include a charge-strapping supercapacitor to control efficiency and the amount of burst charging time. Another embodiment is directed to a hysteretic charging scheme including controlling hysteresis, optimizing window size, and controlling a two-stage supercapacitor composition with a pulse-frequency modulation (PFM) dc-dc boost converter. The charging scheme is useful to extend the upper bound on the capacitance of supercapacitors.

### CROSS-REFERENCE TO RELATED APPLICATIONS

This application claims priority to U.S. Provisional Application No. 62/185,308 titled EFFICIENT SUPERCAPACITOR CHARGING TECHNIQUE BY A HYSTERETIC CHARGING SCHEME filed on Jun. 26, 2015, the content of which is expressly incorporated by reference in its entirety.

### FIELD

The present disclosure relates to methods and devices for supercapacitor charging, and more particularly to methods and devices configured for a two-stage supercapacitor composition with a boost converter.

### BACKGROUND

Due to the cost, energy density, and technological maturity, rechargeable batteries are the primary type of energy storage element (ESE) for many embedded-graded systems such as wireless sensor nodes. However, rechargeable batteries can suffer from non-ideal effects such as the memory effect. Moreover, rechargeable batteries have a limited number of recharge cycles. To compensate or overcome these disadvantages, among others, supercapacitors have emerged as a promising ESE in addition to, or in replacement of, rechargeable batteries.

Often, supercapacitors cannot be used as drop-in replacements for the batteries without consideration of many intrinsic characteristics. For example, although the extremely low equivalent serial resistance (ESR) of supercapacitors enables the supercapacitor to deliver high power and fully charge within a few minutes, low ESRs effectively make supercapacitors function as a shorted-circuit during charging phase. Furthermore, a higher leakage current for supercapacitors, when compared to rechargeable batteries, is disadvantageous.

In modeling supercapacitors, the leakage power of a supercapacitor grows rapidly with size (e.g., capacitance) and with remaining energy. For example, at 2.5 V, the leakage power of 22 F, 100 F, and 300 F supercapacitors is approximately 2 mW, 7 mW, and 17 mW, respectively. Once the leakage power of the supercapacitor, at a given voltage, is higher than that of a low ambient source, the net power transfer is actually at a loss. For this reason, the leakage rate should be capped by limiting the capacitance of supercapacitors, limiting the voltage, or both. Implementing a hysteretic charging scheme is useful to extend the upper bound on the chargeable capacitance of supercapacitors.

Due to high leakage rates of supercapacitors, it is difficult to charge supercapacitors under low power conditions. Conventional chargers using continuous pulse-frequency modulation (PFM) mode can fully charge supercapacitors when the capacitance of supercapacitors is less than 1 F under the low-power supply condition of 3 mW. Furthermore, the hysteretic charging scheme increases the charging current to approximately 2 times compared to the maximum power point tracking (MPPT) charging scheme. That is, the hysteretic charging scheme can charge 2 times more quickly than the MPPT charging scheme.

FIG. 1 depicts a schematic of a typical boost converter 100, also known as a step-up dc-dc converter. This dc-dc converter comprises a power stage and a control circuit. The power stage includes one switching cell (e.g., a transistor and a diode) and an output filter (e.g., an inductor and a capacitor). The output voltage Vₒᵤₜ is not only always greater than the input voltage Vᵢₙ, but can be adjusted by adjusting the duty cycle of the switching cell. In the on-state, the gate is closed and the inductor current I_{L} flows through the metal-oxide-semiconductor field-effect transistor (MOSFET). In the off-state, the gate is opened and the accumulated energy of the inductor is transferred to the load through the diode. The drive circuit of the switching cell can operate in either pulse width modulation (PWM) mode or pulse frequency modulation (PFM) modes. The modulation mode is dependent on the load conditions.

FIG. 2A depicts an equivalent circuit model of supercapacitors. The equivalent circuit model of supercapacitors is composed of three components: the equivalent serial resistance (R_{ESR}), the equivalent parallel resistance (R_{EPR}), and the capacitor C_{SCAP}. The R_{ESR} is the internal series resistance, which represents losses in charge or discharge cycle. The R_{EPR} is connected in parallel with the capacitor. The R_{EPR} is used to model the leakage current loss that represents long-term storage characteristics. Since supercapacitor is initially charged, the initial voltage is V₀. Consider the positive and negative terminals of supercapacitor are opened, the voltage dropped by R_{EPR} is a decay of the initial voltage V₀. Thus,

$${V}_{scap} ( t ) = {V}_{0} \cdot {e}^{- \frac{t}{{R}_{EPR} \cdot {C}_{scap}}}$$

Where, R_{EPR} can be calculated. According to the Ohm's law, the leakage current can be written as

$${I}_{scap , leak ( t )} = \frac{{V}_{scap} ( t )}{{R}_{EPR}}$$

As the capacitance of supercapacitors increases, the leakage current of supercapacitors also increases, while R_{ESR} decreases. During the charging phase, when the voltage of the supercapacitor increases, the leakage current is gradually increased proportional to the charged voltage. In order to charge the supercapacitor, under the low ambient power sources, the charging power should be larger than the leakage power. Therefore, the power transfer efficiency of the dc-dc converter and the additional overhead of control circuit are crucial factors to efficiently charge supercapacitors in the subwatt-scale energy harvesters.

FIG. 2B depicts the relationship between leakage current and voltage of supercapacitors. The leakage current of supercapacitors increases with the size (i.e., capacitance) and with the charged voltage, as shown. In fact, high leakage current is main disadvantage of the supercapacitors; therefore, high leakage current must be addressed to charge supercapacitors under low-power source conditions. In order to overcome the leakage of the reservoir supercapacitors, the hysteretic charging mode supercapacitor (of small capacitance) accumulates the energy from the low-power ambient source, and then rapidly releases the accumulated energy to the reservoir supercapacitors within the hysteresis band. The released current (e.g., charging current) through the PFM-mode dc-dc converter can offset the leakage current of reservoir supercapacitor. When the charging current is equal to the leakage current, the charger can no longer charge the reservoir supercapacitor. This is called the boundary of leakage offset current (I_{leak,offset}). In this sense, the leakage offset current can be obtained at the moment that the leakage energy is equivalent to the charging energy of the reservoir supercapacitor during one cycle.

There exists a need for new charger designs that have high efficiency during low power supply and low power consumption conditions.

### BRIEF SUMMARY OF THE EMBODIMENTS

Disclosed and claimed herein are methods and devices for supercapacitor charging. One embodiment is directed to a supercapacitor charger including a charge-strapping supercapacitor configured to accumulate energy from a low-power source, and a burst control module configured to release energy accumulated by the charge-strapping supercapacitor, wherein a burst transfer window for releasing energy by the burst control module is controlled by the charge-strapping capacitor. The supercapacitor charger also includes a boost converter configured to charge a reservoir supercapacitor, wherein the boost converter is enabled and disabled by the burst control module based on the burst transfer window.

In one embodiment, the charge-strapping supercapacitor is between the range of 2 F to 5 F.

In one embodiment, the charge-strapping supercapacitor includes a charge time based on a leakage current of the reservoir supercapacitor.

In one embodiment, the burst control module includes a non-inverting comparator configured to provide burst-transfer window control.

In one embodiment, the burst control module enables the boost converter based on the charge-strapping supercapacitor approaching an upper bound of the burst transfer window and wherein the burst control module disables the boost converter when the voltage of the charge-strapping supercapacitor drops to a lower bound of the burst transfer window.

In one embodiment, the burst control module turns the boost control on to charge the reservoir supercapacitor at the maximum power point of the low power source.

In one embodiment, the boost converter is a pulse-frequency modulation (PFM) dc-dc boost converter.

In one embodiment, the boost converter transfers stored energy of the charge-strapping supercapacitor to the reservoir supercapacitor during the burst transfer window.

In one embodiment, the burst transfer window is an adjustable burst window.

In one embodiment, the charge-strapping supercapacitor is arranged in parallel with the boost converter and the reservoir supercapacitor, and wherein the burst controller controls connection of the charge-strapping supercapacitor to the boost converter.

In one embodiment, the low power source is at least one of a thermoelectric generator, fuel cell, galvanic corrosion source, and photovoltaic cell.

One embodiment is directed to a supercapacitor charger including a charge-strapping supercapacitor configured to accumulate energy from a low-power source, wherein the charge-strapping supercapacitor includes a charge time based on a leakage current of the reservoir supercapacitor. The supercapacitor charger also includes a burst control module configured to release energy accumulated by the charge-strapping supercapacitor, wherein a burst transfer window for releasing energy by the burst control module is controlled by the charge-strapping capacitor burst control module enables the boost converter based on the charge-strapping supercapacitor approaching an upper bound of the burst transfer window and wherein the burst control module disables the boost converter when the voltage of the charge-strapping supercapacitor drops to a lower bound of the burst transfer window. The supercapacitor charger also includes a boost converter configured to charge a reservoir supercapacitor, wherein the boost converter is a pulse-frequency modulation (PFM) dc-dc boost converter, and wherein the boost converter is enabled and disabled by the burst control module based on the burst transfer window.

One embodiment is directed to a method of implementing a hysteretic charging scheme supercapacitor charger including controlling hysteresis, optimizing a window size; and controlling a two-stage supercapacitor composition with a pulse-frequency modulation dc-dc boost converter.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a typical boost converter schematic;

FIG. 2A depicts an equivalent circuit model of supercapacitors;

FIG. 2B depicts the relationship between leakage current and voltage of supercapacitors;

FIG. 3 depicts a block diagram of a supercapacitor charger according to one or more embodiments;

FIG. 4A depicts a circuit for implementing hysteresis using a positive feedback according to one or more embodiments;

FIG. 4B depicts the transfer curve of the non-inverting comparator with hysteresis according to one or more embodiments;

FIGS. 5A and 5B depict waveforms of reservoir supercapacitor voltage according to one or more embodiments;

FIG. 6 depicts a comparison of results between conventional continuous charging scheme and hysteretic charging-mode charging scheme according to one or more embodiments;

FIG. 7 depicts the boundary between charging current and leakage current according to one or more embodiments;

FIG. 8 depicts a working prototype stage of the hardware architecture for the hysteretic charging-mode boost charger according to one or more embodiments;

FIG. 9 depicts a process for supercapacitor charging according to one or more embodiments; and

FIG. 10 depicts determining capacitance of a charge-strapping supercapacitor according to one or more embodiments according to one or more embodiments.

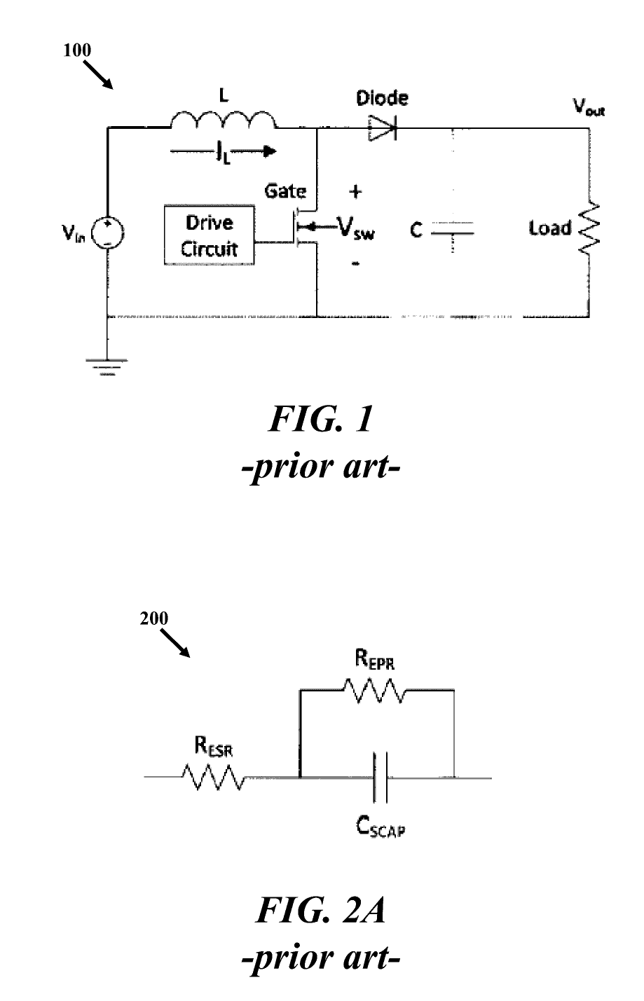

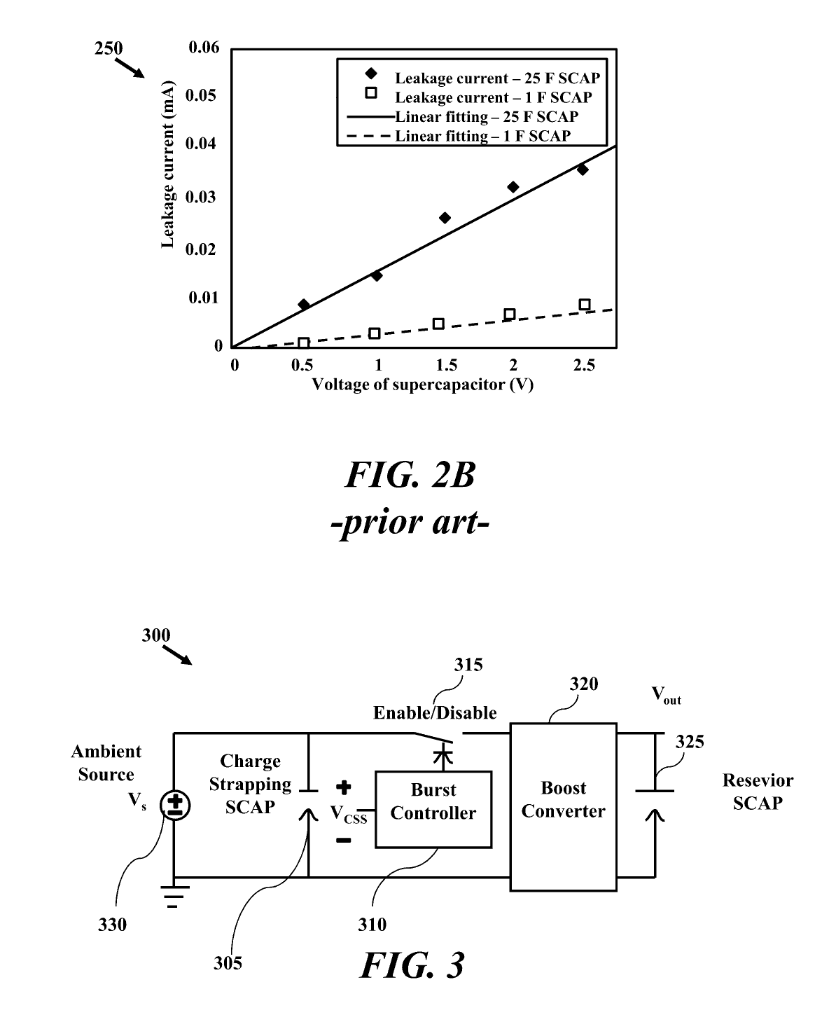

### DETAILED DESCRIPTION OF THE EXEMPLARY EMBODIMENTS

### Overview and Terminology

One aspect of the disclosure is to provide efficient supercapacitor charging, and in particular supercapacitor charging under low-ambient power conditions. In one embodiment, a burst transfer mode dc-dc boost converter for efficient supercapacitor charging is provided. The supercapacitor charger achieves efficient operations through burst-transfer control and two-stage supercapacitors topology based on a dc-dc boost converter. The burst-transfer charging scheme turns on the boost converter and then transfers the stored energy of a first-stage supercapacitor (of small capacitance) to a second-stage reservoir supercapacitor (of large capacitance) instantaneously, which can charge the reservoir supercapacitors from the low ambient-power sources by offsetting the leakage of the supercapacitor supercapacitor. Experimental results from simulation and measurement show that the BurstCap charger achieves up to 90% charging efficiency under the low supply-power condition of short-circuit current of 3 mA and open-circuit voltage of 0.9 V operated at the optimal burst-transfer window of 50 mV. As a result, the charging scheme facilitates the use of supercapacitors for powering wireless nodes from low ambient-power sources. More importantly, it enables maintenance-free operation of wireless sensing systems with supercapacitor-based energy storage in harsh environments, where sunlight or wind power may be unavailable or unpredictable.

In another embodiment, a charging apparatus is disclosed. The apparatus includes a hysteresis control module, a window size optimization module, and a pulse-frequency modulation dc-dc boost converter, configured to control a two-stage supercapacitor composition.

In another embodiment, a hysteretic charging-mode boost charger can get the best charging efficiency by finding the optimum hysteresis window through an ultralow-power circuit. The hysteretic charging-mode mode boost charger can improve the storage capacity. As a result, the proposed charging scheme enhances the charging ability and to the charging efficiency of the supercapacitor-based energy harvester under the low-power ambient source.

According to another embodiment, methods are provided for supercapacitor charging. In one embodiment, a method is provided for implementing a hysteretic charging scheme. The method includes controlling hysteresis, optimizing window size, and control a two-stage supercapacitor composition with a pulse-frequency modulation (PFM) dc-dc boost converter.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

Referring now to the figures, FIG. 3 depicts a block diagram of a supercapacitor charger according to one or more embodiments. Supercapacitor charger 300 includes a charge-strapping supercapacitor 305, burst control module 310, and boost converter 320. Supercapacitor charger 300 is configured to charge reservoir capacitor 325 using a low power source, such as ambient low power source 330. In one embodiment, supercapacitor charger 300 includes charge-strapping supercapacitor 305 arranged in parallel with the boost converter 320 and the reservoir supercapacitor 325, such that burst controller 310 controls connection of the charge-strapping supercapacitor 305 to the boost converter 320.

In one embodiment, supercapacitor charger 300 is a hysteretic charging-mode charger. According another embodiment, supercapacitor charger 300 is a hysteretic charging mode dc-dc boost converter for efficient charging of supercapacitors under the low-ambient source conditions.

Charge-strapping supercapacitor 305 is configured to accumulate energy from a low-power source 330. In one embodiment, charge-strapping supercapacitor 305 is used to set a burst transfer window for releasing energy by burst control module 310. Unlike typical boost dc-dc converters, the input ceramic capacitor is replaced with a supercapacitor, named a charge-strapping supercapacitor 305 with smaller capacitance (e.g., 1 F to 5 F) compared to the capacitance of reservoir supercapacitors. In one embodiment, charge-strapping supercapacitor 305 is between the range of 2 F to 5 F. According to another embodiment, charge-strapping supercapacitor 305 includes a charge time based on a leakage current of the reservoir supercapacitor 325.

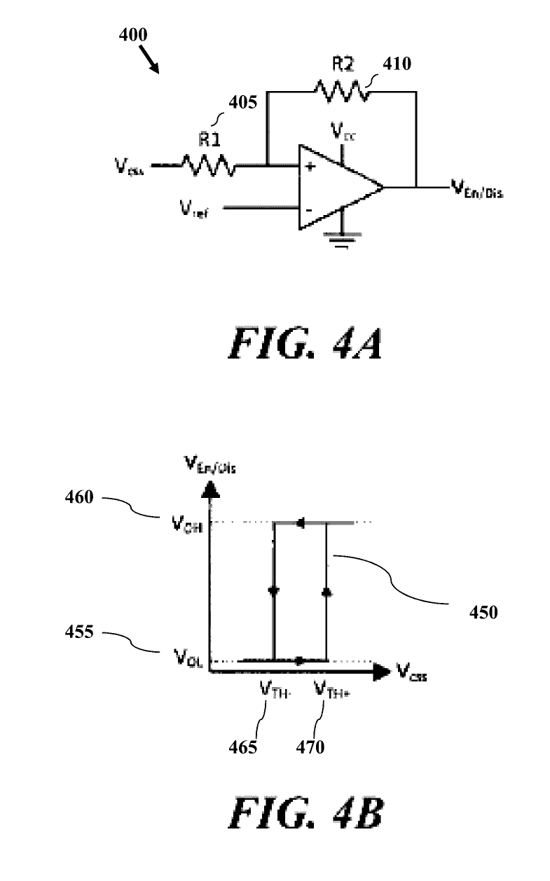

Burst control module 310 is configured to release energy accumulated by the charge-strapping supercapacitor. In one embodiment, burst control module controls release of energy by charge-strapping supercapacitor 305 based on enabling/disabling shown by switch 315. In one embodiment, burst control module 310 includes a non-inverting comparator configured to provide burst-transfer window control, such as circuit 400 of FIG. 4A. Burst control module 310 enables the boost converter 320 based on the charge-strapping supercapacitor 305 approaching an upper bound of the burst transfer window and the burst control module 310 disables the boost converter 320 when the voltage of the charge-strapping supercapacitor 305 drops to a lower bound of the burst transfer window. In one embodiment, burst control module 310 turns the boost control 320 on to charge the reservoir supercapacitor at the maximum power point of the low power source.

Boost converter 320 is configured to charge a reservoir supercapacitor 325. In one embodiment, boost converter 320 is enabled and disabled by the burst control module 310 based on a burst transfer window. In one embodiment, boost converter 320 is a pulse-frequency modulation (PFM) dc-dc boost converter. Boost converter 320 transfers stored energy of the charge-strapping supercapacitor 305 to the reservoir supercapacitor 325 during the burst transfer window. The burst transfer window is an adjustable burst window.

In one embodiment, a hysteretic supercapacitor charger is provided by a combination of a small charge-strapping supercapacitor 305 and a large reservoir supercapacitor 325. The burst control 310 may include a switch controller to enable and disable the boost converter 320 within the hysteretic window. Once of the voltage of the charge-strapping supercapacitor 305 gradually increases and approaches the upper bound of the hysteretic window, the burst control 310 enables the boost converter 320 and transfers the stored energy of the charge-strapping supercapacitor 305 until the voltage of the voltage of charge-strapping supercapacitor 305 drops to the lower bound of the hysteretic window. Additionally, the boost converter 320 supports two control modes of PWM and PFM, which will be selectable by external control signal to improve charging efficiency.

According to one embodiment, under high ambient-power conditions, the stored energy of the charge-strapping supercapacitor 305 is enough so that the burst controller 310 turns the boost converter 320 on and charges the reservoir supercapacitor 325 at the maximum power point (MPP) of the ambient energy transducer/source 300. However, considering the limited ambient power, if the boost converter 320 is always enabled to charge the reservoir supercapacitor 325, then the input voltage drops because the reservoir supercapacitor acts 325 as a short-circuit during charging phase; hence, the power-conversion efficiency of the boost converter 320 is significantly lower. Accordingly, in one embodiment a burst charging scheme first accumulates the low energy in the small charge-strapping supercapacitor 305 by disabling the boost converter 320, and then releases the stored energy to the reservoir supercapacitor 325 during the period of the burst-transfer window. Since this burst control can avoid the insufficient supply condition and the power dissipation of the boost converter 320, the charging efficiency is ultimately improved.

In low ambient energy applications, if the boost converter 320 is always enabled to charge the reservoir supercapacitor 325, the input voltage is effectively dropped because the reservoir supercapacitor 325 acts as a short-circuit during charging phase; hence, the power-conversion efficiency of the boost converter 320 is significantly reduced. By comparison, the hysteretic charging scheme first accumulates the low ambient energy to the small charge-strapping supercapacitor 305 by disabling the boost converter 320, then releases the stored energy to reservoir supercapacitor 325 during the period of hysteretic window. Since this switch control 315 can avoid the virtual short-circuit issue of the supercapacitor charger, the charging efficiency is improved. The hysteretic charging scheme increases the chargeable size of supercapacitor by overcoming the high leakage of supercapacitors.

In one embodiment, supercapacitor charger 300 is a hysteretic charging-mode charger for efficient supercapacitor charging under the low ambient power conditions. In one embodiment, supercapacitor charger 300 provides efficient operations through hysteretic control, optimal window size, and two-stage supercapacitor composition by implementing a pulse-frequency modulation (PFM) dc-dc boost converter 320. Low power source 330 may be at least one of a thermoelectric generator, fuel cell, galvanic corrosion source, and photovoltaic cell.

According to one embodiment, since low ambient energy sources 330 typically have low output voltage, a voltage step-up scheme is used to boost the low-output voltage of ambient energy sources to charge a supercapacitor or power the control circuit, such as reservoir supercapacitor 325. Moreover, the self-discharge (leakage) rate of supercapacitors increases rapidly near their rated voltage. The magnitude of this leakage rate can approach, and potentially exceed, the charging current. One or more embodiments address these issues and provide schemes developed for efficiently charging a supercapacitor under the low power conditions.

In another embodiment, a hysteretic charging scheme can charge the large capacitance of reservoir supercapacitors under the condition of low-power ambient source by offsetting the leakage current of the reservoir supercapacitor. In one embodiment, supercapacitor charger 300 provides a charger scheme including controlling hysteresis, optimizing a window size (e.g., burst window) and controlling a two-stage supercapacitor composition with a pulse-frequency modulation dc-dc boost converter. Similarly, supercapacitor charger 300 can include a hysteresis control module or burst control module 310, a window size optimization module, and a pulse-frequency modulation dc-dc boost converter 320, configured to control a two-stage supercapacitor composition.

### Adjustable Burst Window

FIG. 4A depicts a circuit 400 for implementing hysteresis using a positive feedback. In this embodiment, a non-inverting comparator 400 with hysteresis is implemented. FIG. 4B depicts the transfer curve 450 of the non-inverting comparator with hysteresis.

VOL, shown as 455, is the low state saturation voltage and VOH, shown as 460, is the high state saturation voltage. VTH−, shown as 465, is the low threshold voltage and VTH+, shown as 470, is the high threshold voltage, which can be written as

$${V}_{TH +} = \frac{R 1}{R 2} ( {V}_{ref} - {V}_{OL} ) + {V}_{ref}$$

$${V}_{TH -} = \frac{R 1}{R 2} ( {V}_{ref} - {V}_{OH} ) + {V}_{ref}$$

Hence, the hysteresis window size can be expressed as

$${V}_{hyst} = {V}_{TH +} - {V}_{TH -} = \frac{R 1 }{R 2} ( {V}_{OH} - {V}_{OL} )$$

Based on the hysteresis window size equation noted above, the hysteretic window size can be adjusted by modifying the values of R1, shown as 405, or R2, shown as 410. In an embodiment, adjustment is made by substituting the fixed resistors of R1 and R2 into a potentiometer.

The low ambient-power source is modeled as an independent voltage source Vₛ with an equivalent source resistor Rₛ as shown in FIG. 4. To generate _{Isc} of 3 mA and _{Voc} of 0.9 V, we set Vₛ=0.9 V and Rₛ=30052 for the low ambient-power source model. Since the charge-strapping supercapacitor is uncharged initially, we can assume that at time t=0, the initial voltage is 0 V. For t>0, the charge-strapping supercapacitor starts to charge, and the voltage across the supercapacitor _{(Vcss)} can be expressed as:

$$Vcss ( t ) = Vs ( 1 - {e}^{- \frac{t}{RsCcss}} )$$

where _{Ccss} is the capacitance of the charge-strapping supercapacitor. The equivalent series resistance (ESR) of the charge-strapping supercapacitor is ignored, because it is trivial compared to Rₛ.

A burst controller can be implemented with the circuit shown in FIG. 6. _{VOL} denotes the low state saturation voltage, VOH the high state saturation voltage, _{VTH-} the low threshold voltage, and _{VTH+} the high threshold voltage. They can be expressed as

$$VTH += \frac{R 1}{R 2} ( Vref - VOL ) + Vref$$

$$VTH -= \frac{R 1}{R 2} ( Vref - VOH ) + Vref$$

Hence, the burst-transfer window can be

$$Vburst \text{-} window = VTH + - VTH -= \frac{R 1}{R 2} ( VOH - VOL )$$

The burst-transfer window can be adjusted by modifying the values of R1 or R2. This is implemented by substituting the fixed resistors of R1 and R2 into the potentiometer.

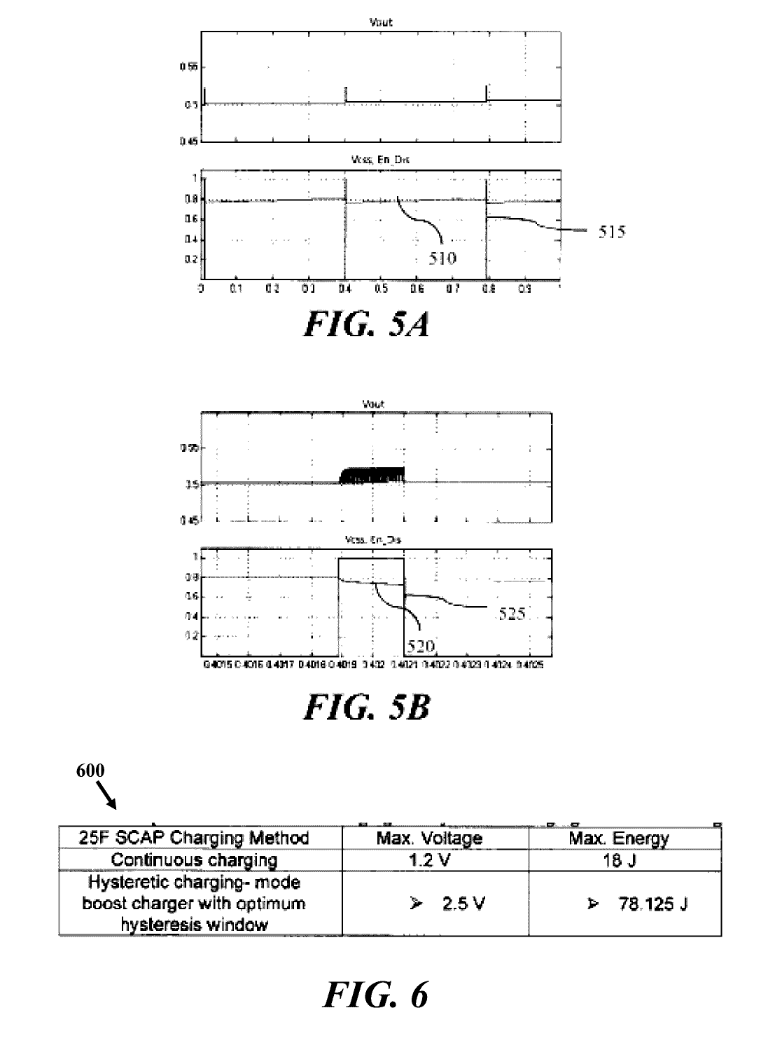

FIGS. 5A and 5B depict waveforms of reservoir supercapacitor voltage. FIG. 5A depicts waveforms of reservoir supercapacitor voltage, enable pulse, and input voltage for charging phase and hysteretic operation. FIG. 5B depicts waveforms of reservoir supercapacitor voltage, enable pulse, and input voltage for zoomed-in hysteretic charging.

In FIGS. 5A and 5B, Vout is the voltage waveform of the reservoir supercapacitor, Vcss, indicated by the magenta line 510, is for the voltage from the charge-strapping supercapacitor, and En_Dis, indicated black solid line 515, is the hysteretic control signal. FIG. 5A depicts the simulation results for 1 second, while FIG. 5B delineates only one En_Dis pulse to clearly show the hysteretic charging operation. The boost converter turns on, indicated by the purple solid line 520, and delivers the stored energy from the 3.3 F charge-strapping supercapacitor to the 25 F reservoir supercapacitor for the short duration. As soon as the 3.3 F supercapacitor voltage, indicated by the blue solid line 525, reaches the lower bound of the hysteretic window (e.g., VTH−=760 mV), the boost converter turns off, and the ambient source starts to charge the 3.3 F supercapacitor again, up to the upper bound of the hysteretic window (e.g., VTH+=810 mV). The charging efficiency can be maximized when the proposed hysteretic supercapacitor charger is operating at PFM mode with 50 mV hysteretic window size and VTH+810 mV. That is, when the hysteresis range is preset from 810 mV to 760 mV of the 3.3 F charge-strapping supercapacitor, the efficiency of the proposed hysteretic supercapacitor charger is maximized.

FIG. 6 depicts a comparison 600 of results between conventional continuous charging scheme and hysteretic charging-mode charging scheme. The comparison 600 uses a 25 F supercapacitor under 3 mA/0.9 V source. The conventional continuous charging scheme can store energy up to 18 J (1.2 V). When the reservoir voltage reaches to 1.2 V, the continuous charging method will waste the energy of source through the leakage current of reservoir supercapacitor. Alternatively, the hysteretic charging-mode charging scheme can store energy up to 78.125 J (2.5 V).

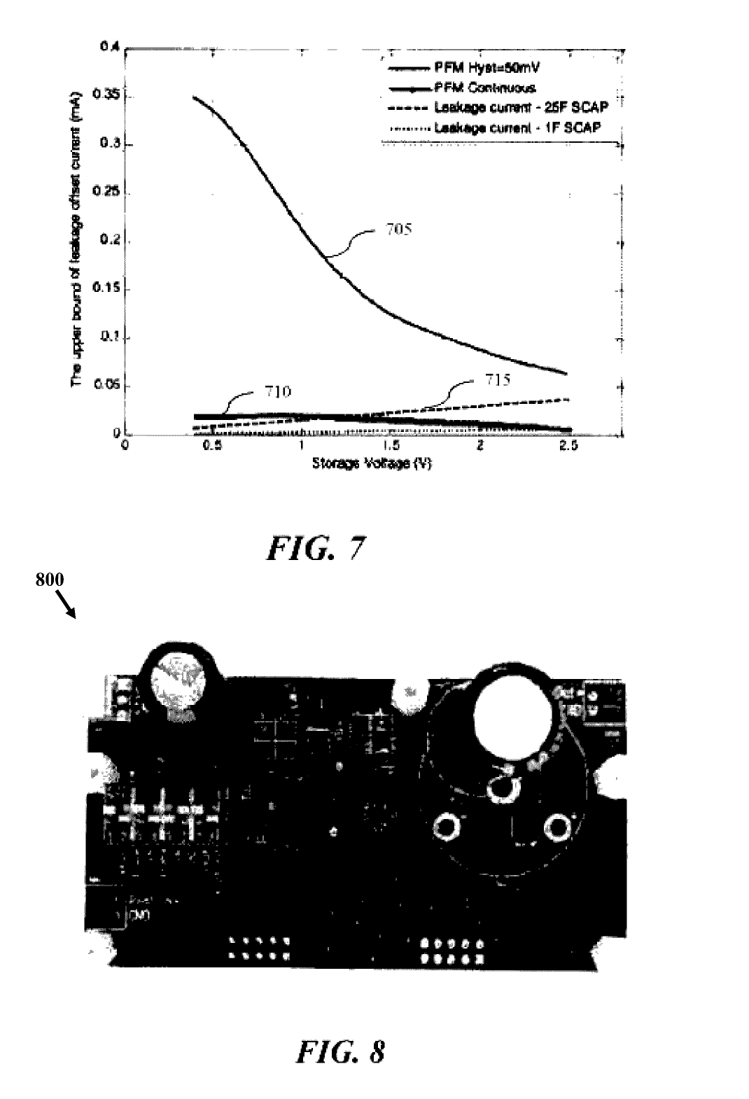

FIG. 7 depicts the boundary between charging current and leakage current, as show through the relationship of leakage offset current to reservoir supercapacitor voltage. The boundary of the proposed hysteretic charging scheme is indicated by a black solid line 705. The conventional continuous charging scheme is marked by a blue solid line 710. In addition, the black dotted-line 715 indicates the leakage current of 25 F supercapacitor, and the blue dotted-line shows the leakage current of the 1 F supercapacitor. Despite of the PFM mode, the conventional continuous charging scheme can fully charge the 1 F supercapacitor to 2.49 V, while it can only charge the 25 F supercapacitor to 1.2 V. On the contrary, the proposed charging scheme can charge the both 1 F and 25 F supercapacitor to more than 2.5 V. That is, the proposed hysteretic charging-mode dc-dc converter increases the charging offset leakage current boundary to 6.7 times at 2.5V, when compared to the conventional charging scheme. The boundary of leakage offset current could be a important parameter to evaluate the supercapacitor charger. If the leakage current of supercapacitors is on the lower side of the boundary of leakage offset current, the supercapacitor charger can fully charge the supercapacitors. Moreover, the different between the boundary of leakage offset current and leakage current of supercapacitors can improve the charging speed of the supercapacitor charger; that is, the large difference presents the supercapacitor charger can charge more quickly by offsetting the leakage current of reservoir supercapacitors.

FIG. 8 depicts a working prototype stage of the hardware architecture for the hysteretic charging-mode boost charger 800. Charger 800 includes a 25 F supercapacitor. Based on tests of charger 800, the charging rate of is faster than that of conventional MPPT-based chargers. In addition, the burst-transfer window has been explored to identify the optimal burst-transfer window size. As a result, efficiency may be improved by optimizing a burst window. In certain embodiments, charger 800 achieves the highest charging efficiency by finding the optimal burst-transfer window through an ultra low-overhead control circuit, as confirmed by our simulation and measurement results on a prototype implementation. When charging a 25-F supercapacitor using an Isc of 3 mA and Voc of 0.9 V source, our burst transfer charging method can charge 25-F supercapacitor to 2.5 V within 112 hours, which is 2 times faster than the conventional MPPT scheme. The reason is that the conventional MPPT scheme has lower leakage-offset current due to the consecutive power consumption of the dc-dc converter, tracking overhead of MPPT tracker, and inaccurate MPP tracking. Charger 800 significantly raises charging current compared to the conventional MPPT charging scheme, thereby effectively utilizing the storage capacity and improving the charging efficiency up to 90% of the supercapacitor-based energy harvester under low ambient-power conditions.

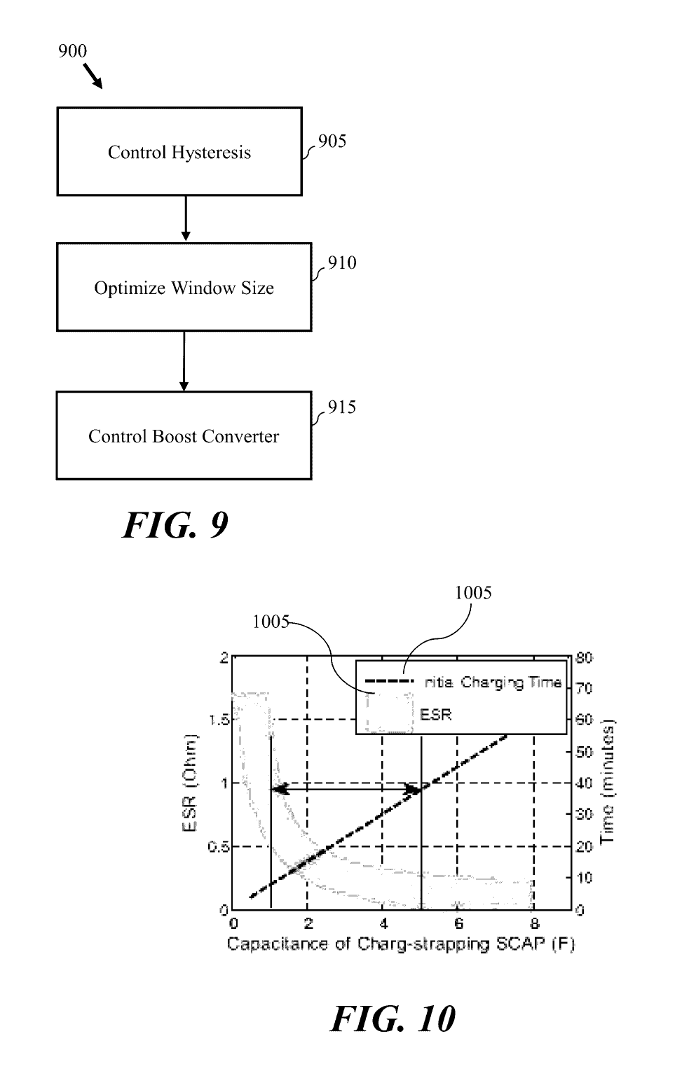

FIG. 9 depicts a process for supercapacitor charging according to one or more embodiments. Process 900 may include controlling hysteresis at block 905, optimizing a window size at block 910, and controlling a two-stage supercapacitor composition with a pulse-frequency modulation dc-dc boost converter at block 915.

Controlling hysteresis at block 905 may be based on a two-stage supercapacitor composition, such as charge-strapping supercapacitor 305 and reservoir capacitor 325, and in particular selection of charge-strapping supercapacitor 305. The two-stage supercapacitor topology may provide a solution to insufficient supply energy, as well as to reduce power consumption of the dc-dc burst converter 320. Optimization of window size at block 910 may be based on burst controller 310.

### Charge Strapping Supercapacitor Selection

FIG. 10 depicts determining capacitance of a charge-strapping supercapacitor according to one or more embodiments. In one embodiment, the values of a charge-strapping supercapacitor (e.g., charge-strapping supercapacitor 305) at the first stage, C_{css} and R_{esr,css} are key parameters to control the efficiency 1005 and the amount of burst charging time 1010. Assuming the current from the ambient energy sources is relatively constant, the charging time 1010 of the charge-strapping supercapacitor is proportional to its value capacitance. Also, this charging time 1010 depends on the loss due to R_{esr,css}, which affects the charging efficiency 1005. The initial charging time 1010 is the time that the charge-strapping supercapacitor is connected to the supply power of VS=0.9 V and RS=300Ω, and then charged from 0 V to 0.7 V in FIG. 10. The initial charging time 1010 can be determined by the C_{css} and supply power conditions. Although R_{esr,css} varies depending on the manufacturer, the range of the R_{esr,css} of supercapacitors is less than 1.8Ω. The thick gray line in FIG. 10 delineates the variation of the R_{esr,css}. One characteristic is that as the capacitance drops below 1 F, the R_{esr,css} increased rapidly. To reduce the power loss at the first stage, it is important to select lower R_{esr,css}. Therefore, considering both initial charging time and R_{esr,css}, a suitable value of the capacitance value of the charge-strapping supercapacitor is between 2 F and 5 F. In an exemplary embodiment, the size of 3.3 F may be selected for a charge-strapping supercapacitor.

While this disclosure has been particularly shown and described with references to exemplary embodiments thereof, it will be understood by those skilled in the art that various changes in form and details may be made therein without departing from the scope of the claimed embodiments.

What is claimed is:

1. A supercapacitor charger comprising:
a charge-strapping supercapacitor configured to accumulate energy from a low-power source;
a burst control module configured to release energy accumulated by the charge-strapping supercapacitor, wherein a burst transfer window for releasing energy by the burst control module is controlled by the charge-strapping capacitor; and
a boost converter configured to charge a reservoir supercapacitor, wherein the boost converter is enabled and disabled by the burst control module based on the burst transfer window.

2. The supercapacitor charger of claim 1, wherein the charge-strapping supercapacitor is between the range of 2 F to 5 F.

3. The supercapacitor charger of claim 1, wherein the charge-strapping supercapacitor includes a charge time based on a leakage current of the reservoir supercapacitor.

4. The supercapacitor charger of claim 1, wherein the burst control module includes a non-inverting comparator configured to provide burst-transfer window control.

5. The supercapacitor charger of claim 1, wherein the burst control module enables the boost converter based on the charge-strapping supercapacitor approaching an upper bound of the burst transfer window and wherein the burst control module disables the boost converter when the voltage of the charge-strapping supercapacitor drops to a lower bound of the burst transfer window.

6. The supercapacitor charger of claim 1, wherein the burst control module turns the boost control on to charge the reservoir supercapacitor at the maximum power point of the low power source.

7. The supercapacitor charger of claim 1, wherein the boost converter is a pulse-frequency modulation (PFM) dc-dc boost converter.

8. The supercapacitor charger of claim 1, wherein the boost converter transfers stored energy of the charge-strapping supercapacitor to the reservoir supercapacitor during the burst transfer window.

9. The supercapacitor charger of claim 1, wherein the burst transfer window is an adjustable burst window.

10. The supercapacitor charger of claim 1, wherein the charge-strapping supercapacitor is arranged in parallel with the boost converter and the reservoir supercapacitor, and wherein the burst controller controls connection of the charge-strapping supercapacitor to the boost converter.

11. The supercapacitor charger of claim 1, wherein the low power source is at least one of a thermoelectric generator, fuel cell, galvanic corrosion source, and photovoltaic cell.

12. A supercapacitor charger comprising:
a charge-strapping supercapacitor configured to accumulate energy from a low-power source, wherein the charge-strapping supercapacitor includes a charge time based on a leakage current of the reservoir supercapacitor;
a burst control module configured to release energy accumulated by the charge-strapping supercapacitor, wherein a burst transfer window for releasing energy by the burst control module is controlled by the charge-strapping capacitor burst control module enables the boost converter based on the charge-strapping supercapacitor approaching an upper bound of the burst transfer window and wherein the burst control module disables the boost converter when the voltage of the charge-strapping supercapacitor drops to a lower bound of the burst transfer window; and
a boost converter configured to charge a reservoir supercapacitor, wherein the boost converter is a pulse-frequency modulation (PFM) dc-dc boost converter, and wherein the boost converter is enabled and disabled by the burst control module based on the burst transfer window.

13. The supercapacitor charger of claim 12, wherein the charge-strapping supercapacitor is between the range of 2 F to 5 F.

14. The supercapacitor charger of claim 12, wherein the burst control module includes a non-inverting comparator configured to provide burst-transfer window control.

15. The supercapacitor charger of claim 12, wherein the burst control module turns the boost control on to charge the reservoir supercapacitor at the maximum power point of the low power source.

16. The supercapacitor charger of claim 12, wherein the boost converter transfers stored energy of the charge-strapping supercapacitor to the reservoir supercapacitor during the burst transfer window.

17. The supercapacitor charger of claim 12, wherein the burst transfer window is an adjustable burst window.

18. The supercapacitor charger of claim 12, wherein the charge-strapping supercapacitor is arranged in parallel with the boost converter and the reservoir supercapacitor, and wherein the burst controller controls connection of the charge-strapping supercapacitor to the boost converter.

19. The supercapacitor charger of claim 12, wherein the low power source is at least one of a thermoelectric generator, fuel cell, galvanic corrosion source, and photovoltaic cell.

20. A method of implementing a hysteretic charging scheme comprising:
controlling hysteresis;
optimizing a window size; and
controlling a two-stage supercapacitor composition with a pulse-frequency modulation dc-dc boost converter.
